(19) United States
(12) Patent Application Publication
(10) Pub. No.: US 2012/0146904 A1
(43) Pub. Date: Jun. 14, 2012

(54) APPARATUS AND METHOD FOR CONTROLLING PROJECTION IMAGE

(75) Inventors: Seung Chul KIM, Daejeon (KR); Chung Hyun AHN, Daejeon (KR); Jin Woo HONG, Daejeon (KR)

(73) Assignee: Electronics and Telecommunications Research Institute, Daejeon (KR)

(21) Appl. No.: 13/323,755

(22) Filed: Dec. 12, 2011

(30) Foreign Application Priority Data
Dec. 13, 2010 (KR) 10-2010-0127031
May 30, 2011 (KR) 10-2011-0051419

(51) Int. Cl. G06F 3/033

(52) U.S. Cl. 345/158

(57) ABSTRACT

Disclosed are an apparatus and a method related with a user interface that allows a user to easily use services provided by equipment when output images of video equipment are projected onto an external screen by a projector. According to exemplary embodiments of the present invention, a human body may be used as a pointer to form a shadow, and the shadow may be analyzed to control the projection image. Therefore, the projection image can be controlled without using an interface device, which can provide an easy and intuitive user interface to a user.

### CROSS-REFERENCE TO RELATED APPLICATIONS

This application claims priority to and the benefit of Korean Patent Applications No. 10-2010-0127031 and 10-2011-0051419 filed in the Korean Intellectual Property Office on Dec. 13, 2010 and May 30, 2011, the entire contents of which are incorporated herein by reference.

### TECHNICAL FIELD

The present invention relates to an apparatus and a method for controlling a projection image and more particularly, to an apparatus and a method for controlling a projection image without using an interface device such as a remote controller, a mouse, or a keyboard.

### BACKGROUND ART

Generally, when a user watches an image that is projected onto an external screen by connecting equipment including a port outputting an image to an external, such as a TV, a terrestrial/cable/satellite broadcasting receiver, CD/DVD player, or a computer, with a projector, an input device such as a remote controller, a keyboard, or a mouse selected for the equipment performs the interface between the user and the equipment.

In the case of a user interface that uses a remote controller, the user interface is easy to use, but the interface is less intuitive for manipulation other than for a simple manipulation for changing a TV channel or playing a multimedia, and is not suitable for pointing action or clicking action. In contrast, a user interface that uses a keyboard/a mouse can easily perform complicated and various controls, but it is inconvenient when the user interface is used at a living room.

### SUMMARY OF THE INVENTION

The present invention has been made in an effort to provide an apparatus and a method for controlling a projection image which controls the projection image by analyzing a shadow included in an input image.

An exemplary embodiment of the present invention provides an apparatus for controlling a projection image, including: a shadow deriving unit configured to analyze a shape of a shadow included in an input image to derive semantics of the shadow; and a projection image controller configured to control the projection image using the derived semantics of the shadow.

The apparatus may further includes an image projecting unit configured to project the projection image onto a screen; and an image capturing unit configured to form the shadow generated by a pointer on one side of the screen and capture the projection image and an image including the shadow. The projection image controller may sequentially control the image projecting unit and the image capturing unit so that the capture image is input as an input image. More preferably, the image capturing unit uses a human body as the pointer.

The shadow deriving unit may includes: an area extracting unit configured to extract an area including the shadow from the input image; an image correcting unit configured to correct an image distortion in the extracted area; and a semantics deriving unit configured to derive semantics of the shadow by analyzing an area including a corrected shadow.

The shadow deriving unit may recognizes at least one of a pointing position of a pointer included in the shadow, a shape of the pointer included in the shadow, and a moving direction of the pointer included in the shadow to derive the semantic of the shadow. The shadow deriving unit may recognizes the pointing position of the pointer, the shape of the pointer, and the moving direction of the pointer on the basis of a boundary value of the shadow.

The shadow deriving unit may controls the current position of the pointer included in the shadow to be displayed on the projection image or to track the moving trajectory of the pointer to display the trajectory together with the projection image. If the pointer is positioned within a predetermined radius from the current position for a predetermined period of time, the shadow deriving unit may derives the semantics of the shadow based on the current position of the pointer.

Another exemplary embodiment of the invention provides a method for controlling a projection image, including: deriving semantics of a shadow by analyzing a shape of the shadow included in an input image; and controlling a projection image using the derived semantics of the image.

Before the deriving of the shadow, the method may includes: projecting a projection image onto a screen in response to the control of a projection image controller that performs the controlling of the projection image; forming a shadow generated by the pointer on one side of the screen; capturing the projection image and an image including the shadow; and inputting the captured image as an input image in response to the control of the projection image controller. The forming of the shadow may uses a human body as a pointer.

The deriving of the shadow may includes: extracting an area including a shadow from the input image; correcting an image distortion in an extracted area; and deriving semantics of the shadow by analyzing an area including a corrected shadow.

The deriving of the semantics of the shadow may recognizes at least one of a pointing position of a pointer included in the shadow, a shape of the pointer included in the shadow, and a moving direction of the pointer included in the shadow to derive the semantics of the shadow. The deriving of the shadow may recognize the pointing position of the pointer, the shape of the pointer, and the moving direction of the pointer on the basis of the boundary value.

The deriving of the semantics of the shadow may controls the current position of the pointer included in the shadow so as to be displayed on the projection image or controls to track a moving trajectory of the pointer so as to display the trajectory together with the projection image. If the pointer is positioned within a predetermined radius from the current position for a predetermined period of time, the deriving of the semantics of the shadow may derives the semantics of the shadow based on the current position of the pointer.

According to exemplary embodiments of the present invention, the following advantages can be achieved:

First, a human body is used as a pointer to form a shadow and the shadow is analyzed to control a projection image, so that the projection image can be controlled without using an interface device such as a remote controller, a mouse, or a keyboard. Second, when a user wants to watch a TV, a movie or a computer using a projector, it is possible to provide a more convenient and intuitive user interface to the user by using a shadow formed by the projector.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic block diagram illustrating a projection image control apparatus according to an exemplary embodiment of the present invention.

FIG. 2A is a block diagram illustrating components which are added to the projection image control apparatus.

FIG. 2B is a block diagram illustrating some of components of the projection image control apparatus.

FIG. 3 is a diagram illustrating a projection image control apparatus according to an exemplary embodiment of the present invention.

FIG. 4 is a flow chart schematically illustrating a projection image control method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. Further, if it is considered that the detailed description of a related art or functions thereof may cloud the gist of the present invention, the description thereof may be omitted.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

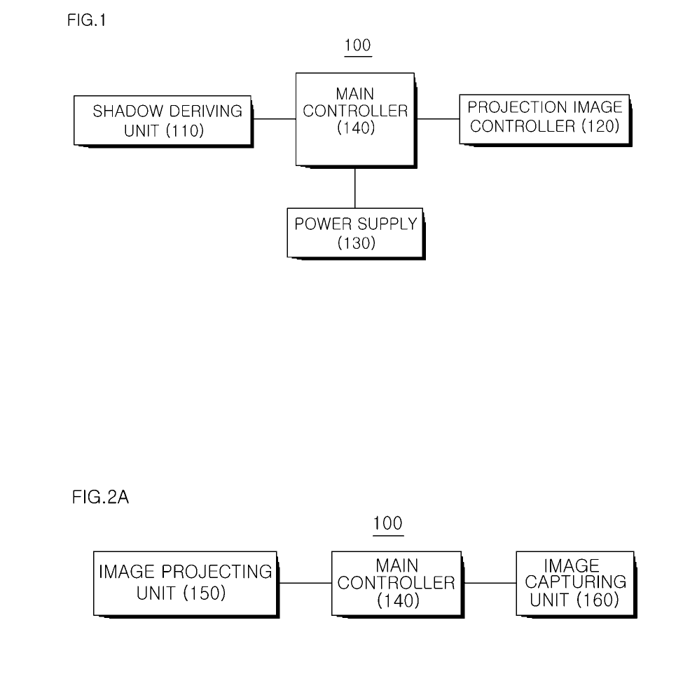

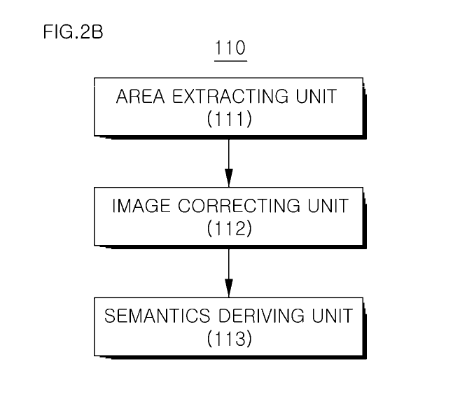

FIG. 1 is a schematic block diagram illustrating a projection image control apparatus according to an exemplary embodiment of the present invention. FIG. 2A is a block diagram illustrating components added to the projection image control apparatus according to the exemplary embodiment, and FIG. 2B is a block diagram illustrating some of components of the projection image control apparatus. The exemplary embodiment of the present invention will be described with reference to FIGS. 1 and 2.

Referring to FIG. 1, a projection image control apparatus 100 includes a shadow deriving unit 110, a projection image controller 120, a power supply 130, and a main controller 140.

The projection image control apparatus 100 according to the exemplary embodiment is an apparatus that allows a user to control a terminal when an image screen output from the terminal is displayed on an external screen by a projector. Specifically, the projection image control apparatus controls the screen by recognizing a shadow.

The shadow deriving unit 110 is configured to analyze a shape of a shadow included in the input image to derive semantics of the shadow.

As shown in FIG. 2B, the shadow deriving unit 110 may include an area extracting unit 111, an image correcting unit 112, and a semantics deriving unit 113. The area extracting unit 111 is configured to extract an area including a shadow from an input image. The image correcting unit 112 is configured to correct an image distortion in the extracted area. The image correcting unit 112 corrects the image distorted by inaccurate installation of a screen onto which an input image is projected or a viewing angle of a camera with respect to a screen. The semantics deriving unit 113 is configured to derive semantics of the shadow by analyzing an area including a corrected shadow.

The shadow deriving unit 110 recognizes at least one of a pointing position of a pointer included in the shadow, a shape of a pointer included in the shadow, and a moving direction of the pointer included in the shadow to derive the semantic of the shadow. In this case, the shadow deriving unit 110 may recognize the pointing position of the pointer, the shape of the pointer, and the moving direction of the pointer on the basis of a boundary value of the shadow. According to the exemplary embodiment, the semantics deriving unit 113 performs the above-mentioned functions of the shadow deriving unit 110.

The shadow deriving unit 110 controls the current position of the pointer included in the shadow so as to be displayed on the projection image or controls to track a moving trajectory of the pointer to display the trajectory together with the projection image. In this case, if the pointer is positioned within a predetermined radius from the current position for a predetermined period of time, the shadow deriving unit 110 may derive the semantics of the shadow based on the current position of the pointer. In the above description, the predetermined period of time may be stored as a parameter of a value defined by a system, and adoptively determined by analyzing the motion of the user. For example, the predetermined period of time may be 5 to 10 seconds and the predetermined radius may be 5 to 10 cm from the current position.

The projection image controller 120 is configured to control the projection image using the derived semantics of the shadow. The shadow deriving unit 110 and the projection image controller 120 have the same concept as a controller which will be described below.

The power supply 140 is configured to supply power to individual units of the projection image control apparatus 100.

The main controller 140 is configured to control the overall operation of the individual units of the projection image control apparatus 100.

As shown in FIG. 2A, the projection image control apparatus 100 may further include an image projecting unit 150 and an image capturing unit 160. The image projecting unit 150 is configured to project a projection image onto a screen. The image capturing unit 160 is configured to form a shadow generated by the pointer on one side of the screen and capture an image including the projection image and the shadow. The image capturing unit 160 may use the human body as the pointer. In this case, the human body refers to a hand or a finger. The image capturing unit 160 may also use a baton or an indicating rod as the pointer. The image projection unit 150 and the image capturing unit 160 have the same concept as a projector or a camera, which will be described below. The screen has the same concept as an external screen, which will be described below.

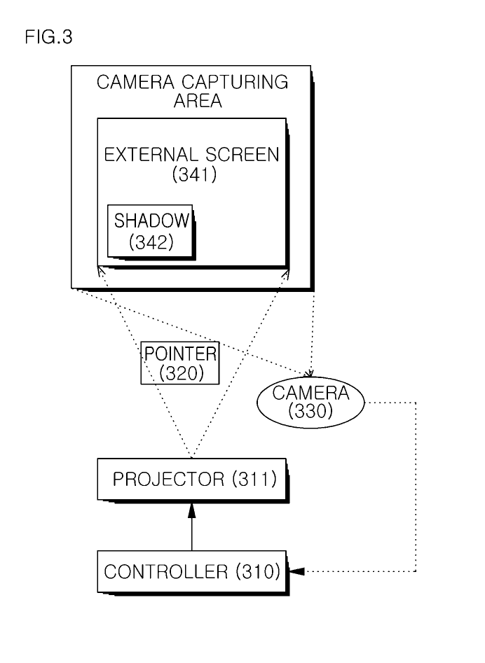

The projection image control apparatus 100 is a user interface related apparatus which allows the user to easily use services provided by video equipment when output images of the video equipment are projected onto the external screen by the projector. An exemplary embodiment of the projection image control apparatus 100 will be described below with reference to FIG. 3. FIG. 3 is a diagram illustrating a projection image control apparatus according to an exemplary embodiment of the present invention. In the meantime, the video equipment includes a TV, a broadcasting receiver, a computer, and various multimedia players.

A controller 310 outputs information regarding an image to be displayed to a projector 311, and receives and processes information of the image that is captured by the camera 330 so as to include an external screen, thereby recognizing the command of a user and performing operation in response to the command.

The projector 311 is configured to project the image information inputted from the controller 310 onto the external screen 341 using a light source.

The external screen 341 includes any means that can display the image projected by the projector 311, and is not limited to a specific term or type.

A pointer 320 is physical means that allows the user to point an arbitrary position on a screen using a shadow of the pointer 320 formed on the external screen 341 or express shapes and motions having different meanings and may utilize a part of a body of the user such as a hand or a finger.

The camera 330 captures an image including the shadow formed by the pointer 320 and the external screen 341 to transmit the image to the controller 310.

The controller 310 can recognize the image while providing a service to the user through the screen. Further, when the controller 310 senses the driving of the projector 311, the controller 310 sets the camera 330 to a status that an image can be inputted or recognizes the image input from the camera 330 as valid data.

Even though the respective lenses of the projector 311 and the camera 330 are preferably provided so as to face the same external screen, the lenses do not need to be close to each other or provided at the same location. That is, it is enough if the camera 330 may be positioned so as to capture four vertexes of the external screen.

The controller 310 receives an image for the external screen including the shadow of the pointer 320 from the camera 330.

The controller 310 may recognize the shadow from the input image using an image processing and recognizing technique. Further, the controller 310 recognizes a tip portion of the pointer to identify the position of the pointer in the screen which is currently being displayed through the external screen.

In the recognized position, the controller 310 provides display means, such as a mouse curser, which allows the user to recognize the current position. If the user moves the pointer 320, the controller 310 continuously tracks the shadow of the pointer and displays the shadow of the pointer on the screen, which allows the user to identify the moving trajectory of the pointer 320 through the external screen.

If the shadow of the pointer stays within a predetermined radius on the basis of a predetermined position on the screen for a predetermined period of time, it has the same result as when the mouse button is clicked at the corresponding position on the screen.

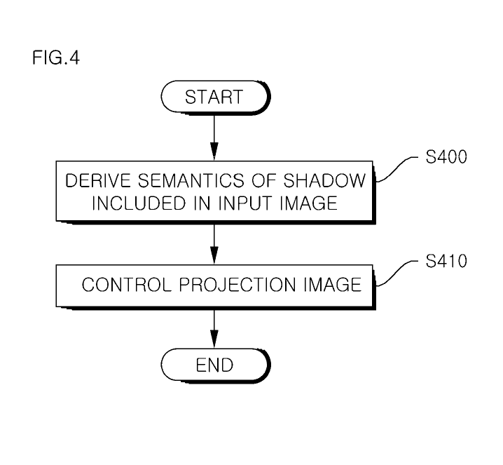

Next, a projection image control method of the projection image control apparatus 100 will be described with reference to FIG. 4. FIG. 4 is a flow chart schematically illustrating a projection image control method according to an exemplary embodiment of the present invention.

First, a shape of a shadow included in an input image is analyzed and then semantics of the shadow is derived (shadow deriving step, S400).

The shadow deriving step S400 may include an area extracting step, an image correcting step, and a semantics deriving step. The area extracting step extracts an area including a shadow from an input image. The image correcting step corrects an image distortion in an extracted area. The semantics deriving step derives semantics of the shadow by analyzing an area including the corrected shadow.

The shadow deriving step S400 recognizes at least one of a pointing position of a pointer included in the shadow, a shape of the pointer included in the shadow, and a moving direction of the pointer included in the shadow to derive the semantics of the shadow. The shadow deriving step S400 may recognize the pointing position of the pointer, the shape of the pointer, and the moving direction of the pointer on the basis of a boundary value of the shadow.

The shadow deriving step S400 controls the current position of the pointer included in the shadow so as to be displayed on the projection image or controls to track a moving trajectory of the pointer to display the trajectory together with the projection image. In this case, if the pointer is positioned within a predetermined radius from the current position for a predetermined period of time, the shadow deriving step S400 may derive the semantics of the shadow based on the current position of the pointer.

After the shadow deriving step S400, the projection image is controlled using the derived semantics of the shadow (projection image control step, S410).

According to the exemplary embodiment, before the shadow deriving step S400, an image projecting step, a shadow forming step, an image capturing step, and an image inputting step may be performed. The image projecting step refers to a step of projecting a projection image onto a screen in response to the control of a projection image controller that performs the projection image control step. The shadow forming step refers to a step of forming a shadow generated by the pointer on one side of the screen. The shadow forming step may use a human body as a pointer. The image capturing step refers to a step of capturing the projection image and an image including the shadow. The image inputting step refers to a step of inputting the captured image as an input image in response to the control of the projection image controller. In the exemplary embodiment of the present invention, the shadow forming step, the image capturing step, and the image inputting step may be performed by the image capturing unit 160.

Next, a projection image control method according to an exemplary embodiment of the present invention will be described. The exemplary embodiment includes six steps.

The first step is an image displaying step that displays an image on an external screen using a projector. The second step is an image inputting step that receives an external screen image including a shadow formed by a pointer such as a hand or a finger using a camera. The third step is a shadow area extracting step that extracts a quadrangular external screen area including the shadow from the input image. The fourth step is an image correcting step that corrects the quadrangular screen of the extracted quadrangular screen distorted by inaccurate installation of the external screen or a viewing angle of a camera for the external screen with respect to a screen into a rectangular screen. The fifth step is a shadow image analyzing step that analyzes the shadow image included in the corrected image to recognize the point indicated by the pointer, the shape of the pointer, and the moving status of the pointer. The sixth step is an operation performing step in response to the recognized result that performs an operation corresponding to the recognized shape or moving status of the pointer, or the position indicated by the pointer.

The exemplary embodiment of the present invention can be applied to a field that controls an output image using a user interface.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for controlling a projection image, comprising:
a shadow deriving unit configured to analyze a shape of a shadow included in an input image to derive semantics of the shadow; and
a projection image controller configured to control the projection image using the derived semantics of the shadow.

2. The apparatus of claim 1, further comprising:
an image projecting unit configured to project the projection image onto a screen; and
an image capturing unit configured to form the shadow generated by a pointer on one side of the screen and capture the projection image and an image including the shadow, or
wherein the projection image controller sequentially controls the image projecting unit and the image capturing unit so that the capture image is input as an input image.

3. The apparatus of claim 2, wherein the image capturing unit uses a human body as the pointer.

4. The apparatus of claim 1, wherein the shadow deriving unit includes:
an area extracting unit configured to extract an area including the shadow from the input image;
an image correcting unit configured to correct an image distortion in the extracted area; and
a semantics deriving unit configured to derive semantics of the shadow by analyzing an area including a corrected shadow.

5. The apparatus of claim 1, wherein the shadow deriving unit recognizes at least one of a pointing position of a pointer included in the shadow, a shape of the pointer included in the shadow, and a moving direction of the pointer included in the shadow to derive the semantic of the shadow.

6. The apparatus of claim 1, wherein the shadow deriving unit controls the current position of the pointer included in the shadow to be displayed on the projection image or controls to track the moving trajectory of the pointer to display the trajectory together with the projection image.

7. The apparatus of claim 6, wherein if the pointer is positioned within a predetermined radius from the current position for a predetermined period of time, the shadow deriving unit derives the semantics of the shadow based on the current position of the pointer.

8. The apparatus of claim 5, wherein the shadow deriving unit recognize the pointing position of the pointer, the shape of the pointer, and the moving direction of the pointer on the basis of a boundary value of the shadow.

9. A method for controlling a projection image, comprising:
deriving semantics of a shadow by analyzing a shape of the shadow included in an input image; and
controlling a projection image using the derived semantics of the image.

10. The method of claim 9, further comprising:
projecting a projection image onto a screen in response to the control of a projection image controller that performs the controlling of the projection image;
forming a shadow generated by the pointer on one side of the screen;
capturing the projection image and an image including the shadow; and
inputting the captured image as an input image in response to the control of the projection image controller.

11. The method of claim 9, wherein the deriving of the semantics of the shadow recognizes at least one of a pointing position of a pointer included in the shadow, a shape of the pointer included in the shadow, and a moving direction of the pointer included in the shadow to derive the semantics of the shadow, or
the deriving of the semantics of the shadow controls the current position of the pointer included in the shadow so as to be displayed on the projection image or
the deriving of the semantics of the shadow controls to track a moving trajectory of the pointer so as to display the trajectory together with the projection image, or
if the pointer is positioned within a predetermined radius from the current position for a predetermined period of time, the deriving of the semantics of the shadow derives the semantics of the shadow based on the current position of the pointer.
